(19) United States
(12) Patent Application Publication
(10) Pub. No.: US 2012/0067476 A1
(43) Pub. Date: Mar. 22, 2012

(54) PNEUMATIC TIRE AND METHOD FOR MAKING A PNEUMATIC TIRE

(76) Inventors: Serge Julien Auguste Imhoff, Schrondweiler (LU); John Woods, Hanau Klein-Auheim (DE); Ralph Joachim Olbrich, Glauburg (DE); Jean-Luc Faure, Villebret (FR); Olivier Marcel Eugene Durand, Domerat (FR); Julia Martine Francoise Claudine Tahon, Bereldange (LU)

(21) Appl. No.: 12/885,737

(22) Filed: Sep. 20, 2010

(51) Int. Cl. B60C 9/00; B29D 30/16; B60C 11/00

(52) U.S. Cl. 152/209.1; 152/451; 156/117

(57) ABSTRACT

A pneumatic tire includes a tire component having a plurality of individually dipped and tackified cords applied individually to the tire component.

### FIELD OF INVENTION

This invention relates to pneumatic tires and, in particular, to high performance automobile and motorcycle tires.

### BACKGROUND OF THE INVENTION

Conventional motorcycle tires utilize very wide treads which, in transverse cross-section, are sharply curved to provide good contact with the road surface when the motorcycle is steeply banked in cornering. Maintenance of a consistent ground contact area or ‘tire footprint’ under all conditions is a major factor in determining general vehicle handling. Of particular importance in race motorcycle tires of radial construction is a characteristic of high cornering power with stability to maximize cornering speeds under race conditions.

Conventional radial motorcycle race tires have short sidewalls which extend to the tread edges radially and axially outwardly from the tires beads. The beads provide engagement to the wheel rim on tapered bead seats. The sidewalls are reinforced by radial carcass plies which, when tensioned by the inflation pressure, act together with sidewall geometry to provide a fixed location for the curved tread regions to withstand cornering forces.

The sharply curved tread region of the conventional tire may be specially reinforced by a reinforcing breaker to give the required structural rigidity to allow for banking over of the motorcycle when cornering while also providing sufficient flexibility to allow localized tread flattening in the ground contact patch for good road grip.

A conventional motorcycle race tire may use a center hard tread compound and differing shoulder tread compounds since some race circuits necessitate uneven shoulder wear and grip.

Conventional processes for producing these tires involve an extrusion or calendering step which increase production cost and which may increase scrap. Any new and innovative manner of producing tires with reduced cost would be commercially desirable.

### DEFINITIONS

The following definitions are controlling for the disclosed invention.

“Apex” means an elastomeric filler element located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Circumferential” means lines or directions extending along the perimeter of the surface of the annular tire parallel to the Equatorial Plane (EP) and perpendicular to the axial direction.

“Cord” means one or more twisted or untwisted yarns such as an assembly of a plurality of twisted yarns. “Cords” may also be referred to as one of the reinforcement strands of which the plies of the tire are comprised.

“Cord angle” means the acute angle, left or right in a plan view of the tire, formed by a cord with respect to the equatorial plane. The “cord angle” is measured in a cured but uninflated tire.

“Denier” means the weight in grams per 9000 meters (unit for expressing linear density). Dtex means the weight in grams per 10,000 meters.

“Elastomer” means a resilient material capable of recovering size and shape after deformation.

“Equatorial plane (EP)” means the plane perpendicular to the tire's axis of rotation and passing through the center of its tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“High Tensile Steel (HT)” means a carbon steel with a tensile strength of at least 3400 MPa @ 0.20 mm filament diameter.

“Inner” means toward the inside of the tire and “outer” means toward its exterior.

“LASE” is load at specified elongation.

“Lateral” means an axial direction.

“Lay length” means the distance at which a twisted filament or strand travels to make a 360 degree rotation about another filament or strand.

“Mega Tensile Steel (MT)” means a carbon steel with a tensile strength of at least 4500 MPa @ 0.20 mm filament diameter.

“Radial” and “radially” are used to mean directions radially toward or away from the axis of rotation of the tire.

“Sidewall” means that portion of a tire between the tread and the bead.

“Super Tensile Steel (ST)” means a carbon steel with a tensile strength of at least 3650 MPa @ 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Tread” means a molded, extruded, or shaped rubber component which, when bonded to a tire casing, includes that portion of the tire that comes into contact with the road when the tire is normally inflated and under normal load.

“Ultra Tensile Steel (UT)” means a carbon steel with a tensile strength of at least 4000 MPa @ 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF INVENTION

A pneumatic tire in accordance with the present invention includes a tire component having a plurality of individually dipped and individually tackified cords applied individually to the tire component. The tire component may be, for example, a tread reinforcement structure for improving high-speed performance and manufacturing of the pneumatic tire.

According to another aspect of the present invention, the cords are monofilaments or twisted yarns.

In one aspect of the invention, the cords are aramid cords with a Dtex in a range of from 400 to 3500 Dtex. Preferably, the Dtex is in a range of from 1500 to 1800 Dtex such as 1670 Detx or 1680 Dtex.

In one aspect of the invention, the cords have a twist multiplier in a range of from 4 to 7, preferably 5 and 6. The “twist multiplier” refers to a number that is an indicator of the helix angle that the one or more yarns in a cord make with respect to a longitudinal axis of a cord. As used herein, the twist multiplier (TM) of a cord is determined according to the following equation which is well known in the textile art:

TM=0.0137CT×(CD)^{1/2}

wherein TM is the twist multiplier; CT is the number of turns per inch (2.54 cm) of cord length; and CD is the sum of the deniers of the yarn(s), and/or sub-groups of the yarns of the cord before any twist is imparted to the yarn subgroups. The twist multiplier of a cord characterizes its physical properties, like tensile, modulus, elongation and fatigue.

According to still another aspect of the present invention, the tread reinforcement structure including a plurality of individually dipped and individually tackified cords oriented from −5° to +5° relative to a circumferential direction of the pneumatic tire.

According to yet another aspect of the present invention, the cords are each constructed of one, two, three or more twisted aramid yarns.

According to still another aspect of the present invention, the tire component is selected from the group consisting of a belt structure, a carcass, an overlay, an undertread, and an apex.

According to yet another aspect of the present invention, a tackified finish is applied to the cords during or after the dipping process.

According to still another aspect of the present invention, the tire component is an overlay disposed radially between a tread, at least one breaker and/or at least one carcass ply.

According to yet another aspect of the present invention, the tackified cords are applied directly on to a carcass structure during a building process of an uncured pneumatic tire.

According to still another aspect of the present invention, the cords are constructed of one of the following materials: aramid, PEN, PET, PVA, PBO, POK, rayon, nylon, carbon, and glass fiber.

A method in accordance with the present invention constructs a pneumatic tire. The method preferably comprises the steps of: first, pretreating an individual cord by dipping the cord in a first solution or emulsion; second, drying the individual cord; third, tackifying a surface of the dipped and dried individual cord with a second solution or emulsion; and fourth, applying the tackified individual cord on a surface of an uncured tire component.

According to another aspect of the present invention, the tackified individual cord is applied to the uncured tire component on a tire building drum.

According to still another aspect of the present invention, the uncured tire component is selected from a group consisting of: a carcass, a belt structure, an overlay, an undertread or a tread cushion layer.

According to still another aspect of the present invention, the second solution or emulsion comprises a rubber compound dissolved in a solvent. Preferably, the solvent comprises a petroleum derivative such as toluene.

According to still another aspect of the present invention, the applying step occurs without calendering of the individual cord.

According to still another aspect of the present invention, the dipping includes dipping the individual cord in the first solution or emulsion, and applying an adhesion promoter and/or dipping the dipped individual cord in a further solution or emulsion prior to the drying step.

According to still another aspect of the present invention, the further solution or emulsion is an aqueous emulsion comprising a rubber latex containing resorcinol formaldehyde (RFL) resin.

### BRIEF DESCRIPTION OF THE DRAWINGS

Further aspects of the present invention will become apparent from the description of the following embodiments in conjunction with the attached diagrammatic drawing in which:

FIG. 1 is a schematic representation of an example motorcycle tire for use with the present invention.

### DESCRIPTION OF AN EXAMPLE EMBODIMENT

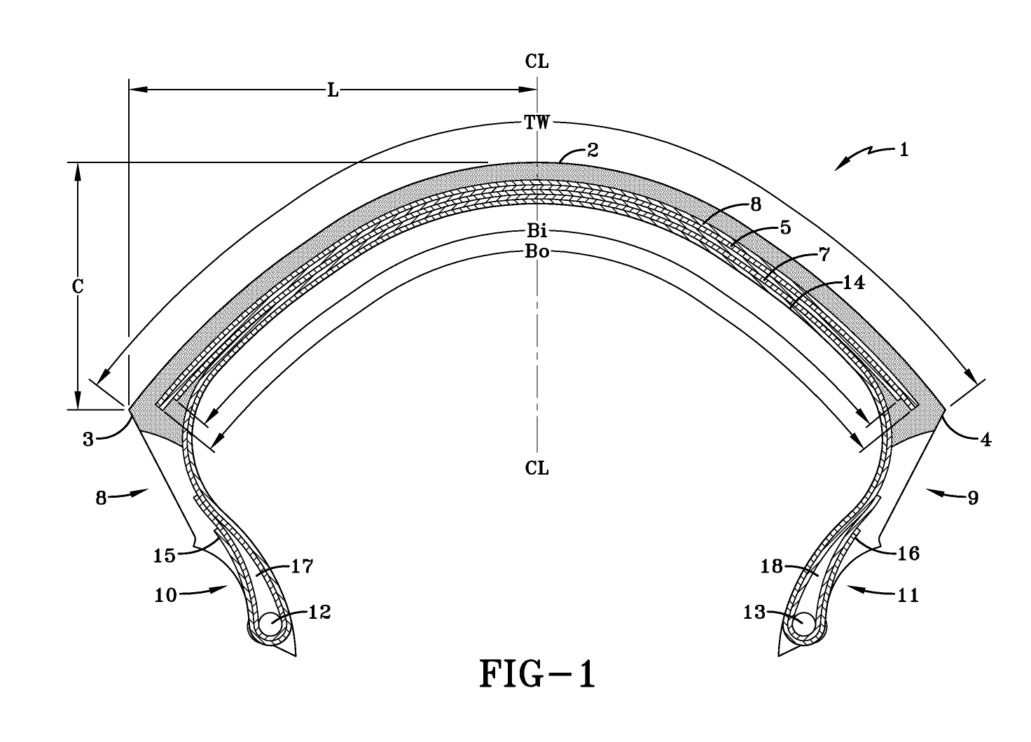

The example motorcycle tire 1 of FIG. 1 includes a pair of sidewalls 8, 9 terminating in bead regions 10, 11. Each bead region 10, 11 is reinforced by an inextensible annular bead core 12, 13. Extending between each bead region 12, 13 is a tire carcass reinforcement ply structure 14 of one or more plies which is/are anchored in each bead region by being turned around each respective bead core 12, 13 laterally from inside to outside to form each ply turn-up 15, 16. The carcass reinforcement ply structure 14 may, for example, comprise a single ply of nylon fabric cords oriented substantially in a radial direction. Each bead region 10, 11 may further comprise a hard rubber apex member 17, 18 anchored to each respective bead core 12, 13 and narrowing/tapering radially outward.

The carcass ply fabric of the example tire 1 may also comprise polyester, rayon, nylon, or para-aramid cords. Further, while a single ply carcass of cords at substantially 90 degrees may be particularly advantageous in the case of tires for the rear wheel of a motorcycle, for the front wheel, a motorcycle tire with two plies of cords crossed at an angle of 70-88 degrees may be utilized.

The example tire 1 may have a camber value of 0.6 and a convex tread region 2, having tread edges 3, 4 reinforced by a breaker assembly (or belt structure) and an overlay 8 in accordance with the present invention. The width TW of the tread may be 220 mm measured along the outer surface. The breaker assembly may comprise zero, one, or two breaker plies 5, 7. As an example, the breaker ply or plies 5, 7 may comprise para-aramid cord tire fabric or other suitable material and construction, such as a steel monofilament ply.

In the example tire 1 of FIG. 1, the cords in the two breaker plies 5, 7 may be oppositely inclined to each other at an angle of 25 degrees to the circumferential direction of the tire. The radially inner breaker ply 7 may have a width Bᵢ of 200 mm and may be narrower than the radially outer breaker ply 5, which may have a width Bₒ of 220 mm. The breaker plies 5, 7 may also comprise steel cords.

The overlay 8 may comprise single end cords, which are individually dipped and subsequently individually tackified (i.e., not calendered). While the cords may be individually dipped, several cords may also be dipped concurrently, moving through a dip process/machine in parallel. For example, the individual cords may be monofilaments, para-aramid 1680/3 Dtex with 240/240 tpm (turns per meter) or other suitable configurations. The selection of materials for the tackified finish may depend greatly upon the materials selected for use in the tire. One of ordinary skill may determine such suitable materials. Tackified finishes may be achieved by various methods such as coating the single end cords in an aqueous or solvent blend of resin and rubber lattices.

An example method in accordance with the present invention may comprise the steps of: first, pretreating an individual cord by dipping the cord in a first solution or emulsion; second, drying the individual cord; third, tackifying a surface of the dipped and dried individual cord with a second solution or emulsion; and fourth, applying the tackified individual cord on a surface of an uncured tire component.

The second solution or emulsion comprises a conventional un-vulcanized rubber compound dissolved in a solvent. Preferably, the solvent comprises a petroleum derivative or distillate such as toluene.

The dipping may include a treatment of the individual cord with an adhesion promoter as part of the dipping process. Typical examples of adhesion promoters include resorcinol formaldehyde latex (RFL), isocyanate based material, epoxy based material, and materials based on melamine formaldehyde resin. To this end, the dipping may include dipping the individual cord in the first solution or emulsion (or in a first bath) and subsequently dipping the dipped individual cord in a further solution or emulsion (or a second bath) prior to the drying step.

Preferably, the further solution or emulsion is an aqueous emulsion (dispersion) comprising a rubber latex containing resorcinol formaldehyde (RFL) resin. The RFL resin may be a primary element of adhesion between the cord and the rubber with the latex also reducing the modulus of the RFL resin.

The tackifying of the surface of the dipped and dried individual cord includes applying a tackified finish for facilitating adhesion, or green tack, during the building process of the green tire. The selection of materials for such tackified finish will depend greatly upon the materials selected for use in the tire, and the skilled person on the basis of his common knowledge can easily determine them appropriately. Tackified finishes can be achieved by various methods such as coating the cord in an aqueous blend of rosin and rubber lattices, or with a solvent solution or emulsion of an un-vulcanized rubber compound.

The cords of the overlay 8 may be oriented in the range of −5° to +5° relative to the circumferential direction of the tire 1. During building of the uncured tire, the cords may be individually placed directly upon an outermost of one or two carcass plies 14 (if no breakers are applied) or the outermost of one or two breakers (breaker 5 in FIG. 1), without any intermediate manufacturing process.

The overlay 8 in accordance with the present invention and the breakers 5, 7 thus provides a tread crown reinforcement structure and may optimize high speed performance for a motorcycle tire, as well as provide excellent handling characteristics, while reducing overall manufacturing efficiency and cost. The present invention accomplishes this by utilizing the individually dipped and individually tackified Single End Dipped (SED) cord(s). Other suitable materials for the SED cords may be aramid, PEN, PET, PVA, PBO, POK, Rayon, Nylon 6, 4,6 and 6,6, carbon, and/or glass fiber. Additionally, the cords for the overlay 8 may be calendered in small strips of 2 or 3 cords.

In accordance with the present invention, the cords may be first dipped in a first “classical” solution and, in a second phase, tackified by a second solution or emulsion (as described above). Once the cord is tackified, the cord will have enough cohesive properties to adhere to an unvulcanized component, such as the overlay 8, carcass 14, breaker 5, 7, tread base, undertread, apex 17, 18, etc.). This provides an improvement over conventional tire building methods, which include an additional calendering step and often generate a higher amount of scrap. Further, cord properties are not affected by calendering and storage. Also, the process provides a simpler and more efficient method, since no weft yarns are needed for weaving and calendering.

In accordance with the present invention, this “ready to use” SED cord overlay 8 may provide a “jointless” belt having a better controlled tension applied to the cord during winding at a tire building machine. This may be critical for strips with multiple cords due to the curvature of a radial motorcycle carcass. The cord at the tread edge may have significantly shorter length compared to the cord at the center of the tread.

As stated above, an overlay 8 or other tire component of SED cords in accordance with the present invention produces excellent handling performance in a tire 1, as well as reducing manufacturing cost. Further, a method in accordance with the present invention provides enhanced efficiency and reduced cost for constructing a pneumatic tire. Thus, the SED cords and method both enhances the performance and/or manufacturing of a pneumatic tire, even though the complexities of the structure and behavior of the pneumatic tire are such that no complete and satisfactory theory has been propounded. Temple, Mechanics of Pneumatic Tires (2005). While the fundamentals of classical composite theory are easily seen in pneumatic tire mechanics, the additional complexity introduced by the many structural components of pneumatic tires readily complicates the problem of predicting tire performance. Mayni, Composite Effects on Tire Mechanics (2005). Additionally, because of the non-linear time, frequency, and temperature behaviors of polymers and rubber, analytical design of pneumatic tires is one of the most challenging and underappreciated engineering challenges in today's industry.

A pneumatic tire has certain essential structural elements. United States Department of Transportation, Mechanics of Pneumatic Tires, pages 207-208 (1981). An important structural element is the overlay, typically made up of many flexible, high modulus cords of natural textile, synthetic polymer, glass fiber, or fine hard drawn steel or other metal embedded in, and bonded to, a matrix of low modulus polymeric material, usually natural or synthetic rubber. Id. at 207 through 208.

The flexible, high modulus cords are usually disposed as a single layer. Id. at 208. Tire manufacturers throughout the industry cannot agree or predict the effect of different twists of overlay cords on noise characteristics, handling, durability, comfort, etc. in pneumatic tires, Mechanics of Pneumatic Tires, pages 80 through 85.

These complexities are demonstrated by the below table of the interrelationships between tire performance and tire components.

| | LINER | CARCASS PLY | APEX | BELT | OV'LY | TREAD | MOLD |
|---|---|---|---|---|---|---|---|
| TREADWEAR | | | | X | | X | X |
| NOISE | | X | X | X | X | X | X |
| HANDLING | | X | X | X | X | X | X |
| TRACTION | | | | | | X | X |
| DURABILITY | X | X | X | X | X | X | X |
| ROLL RESIST | X | | X | X | | X | X |
| RIDE COMFORT | X | X | X | | | X | |
| HIGH SPEED | | X | X | X | X | X | X |
| AIR RETENTION | X | | | | | | |
| MASS | X | X | X | X | X | X | X |

As seen in the table, overlay cord characteristics affect the other components of a pneumatic tire (i.e., overlay affects apex, carcass ply, belt, tread, etc.), leading to a number of components interrelating and interacting in such a way as to affect a group of functional properties (noise, handling, durability, comfort, high speed, and mass), resulting in a completely unpredictable and complex composite. Thus, changing even one component can lead to directly improving or degrading as many as the above ten functional characteristics, as well as altering the interaction between that one component and as many as six other structural components. Each of those six interactions may thereby indirectly improve or degrade those ten functional characteristics. Whether each of these functional characteristics is improved, degraded, or unaffected, and by what amount, certainly would have been unpredictable without the experimentation and testing conducted by the inventors.

Thus, for example, when the structure (i.e., twist, cord construction, etc.) of the overlay of a pneumatic tire is modified with the intent to improve one functional property of the pneumatic tire, any number of other functional properties may be unacceptably degraded. Furthermore, the interaction between the overlay and the apex, carcass ply, belt (or breaker), and tread may also unacceptably affect the functional properties of the pneumatic tire. A modification of the overlay may not even improve that one functional property because of these complex interrelationships.

Thus, as stated above, the complexity of the interrelationships of the multiple components makes the actual result of modification of an overlay 8, in accordance with the present invention, impossible to predict or foresee from the infinite possible results. Only through extensive experimentation have the overlay 8 and cords of the present invention been revealed as an excellent, unexpected, and unpredictable option for a pneumatic tire.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising a tire component having a plurality of individually dipped and individually tackified cords applied individually to the tire component.

2. The pneumatic tire as set forth in claim 1 wherein the tire component is a tread reinforcement structure including a plurality of individually dipped and tackified cords oriented from −5° to +5° relative to a circumferential direction of the pneumatic tire.

3. The pneumatic tire as set forth in claim 1 wherein the cords are constructed of two or three twisted aramid yarns.

4. The pneumatic tire as set forth in claim 1 wherein the tire component is selected from the group consisting of a belt structure, a carcass, an overlay, an undertread or a tread cushion layer.

5. The pneumatic tire as set forth in claim 1 wherein a finish is applied to the dipped cords during or after the dipping process, the finish providing tack to the tire component.

6. The pneumatic tire as set forth in claim 1 wherein the tire component is an overlay disposed radially between the tread and a breaker or between the tread and at least one carcass ply.

7. The pneumatic tire as set forth in claim 1 wherein the cords are applied directly on to the tire component during a building process of an uncured pneumatic tire.

8. The pneumatic tire as set forth in claim 7 wherein the tire component is a carcass structure.

9. The pneumatic tire as set forth in claim 1 wherein the cords are constructed of one of the following materials: aramid, PEN, PET, PVA, PBO, POK, rayon, nylon, carbon, and glass fiber.

10. A method for constructing a pneumatic tire, said method comprising the steps of:
pretreating an individual cord by dipping the individual cord in a first solution or emulsion;
drying the dipped individual cord;
tackifying a surface of the dipped and dried individual cord with a second solution or emulsion; and
applying the tackified individual cord on a surface of an uncured tire component.

11. The method as set forth in claim 10 wherein the tackified individual cord is applied to the uncured tire component on a tire building drum.

12. The method as set forth in claim 10 wherein the uncured tire component is selected from a group consisting of: a carcass, a belt structure, an overlay, an undertread or a tread cushion layer.

13. The method as set forth in claim 10 wherein the second solution or emulsion comprises a rubber compound dissolved in a solvent.

14. The method of claim 13 wherein the solvent comprises a petroleum derivative.

15. The method as set forth in claim 10 wherein said applying step occurs without calendering of the individual cord.

16. The method as set forth in claim 10 wherein the dipping includes dipping the individual cord in the first solution or emulsion and dipping the dipped individual cord in a further solution or emulsion.

17. The method of claim 16 wherein the further solution or emulsion is an aqueous emulsion comprising a rubber latex containing resorcinol formaldehyde (RFL) resin.
